(19) United States
(12) Patent Application Publication
(10) Pub. No.: US 2005/0203757 A1
(43) Pub. Date: Sep. 15, 2005

(54) System and method for pervasive enablement of business processes

(76) Inventors: Hui Lei, Scarsdale, NY (US); Dipanjan Chakraborty, Baltimore, MD (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/797,023

(22) Filed: Mar. 11, 2004

(51) Int. Cl. G06F 17/60

(52) U.S. Cl. 705/1

(57) ABSTRACT

A system and method for pervasive enablement of business processes that effectively integrates workflow technology and ad-hoc collaboration tools. Collaboration tools comprise a plurality of native communication devices capable of interacting with the user either using text or voice mechanism. A modality adapter associated with each collaboration tool (or modality) performs the function of translating staff activities to device-specific messages and receiving replies from the users and sending them back to the engine. A Workflow Engine executes the business process and sends out staff activities meant for human users to the Interaction Controller and other activities meant for software agents to Web Services. An Interaction Controller entity utilizes the Context Service and the Address Book to determine the appropriate modality or collaboration tool for a user and sends the staff activity to the appropriate modality adapter. A Context Service that provides context information, user preferences to the Interaction Controller. The Address Book contains a repository of device addresses specific to each modality a user might use. The system enables users to collaborate with each other anytime and anywhere using an appropriate collaboration modality and participate in backend business processes by performing staff activities using their preferred collaboration device.

### CROSS REFERENCE TO RELATED APPLICATIONS

The subject matter of this application is related to that of patent application Ser. No. 10/349,235 filed Jan. 22, 2003, by Hui Lei and Anand O. Ranganathan for “System and Method for Context-Aware Unified Communication” (IBM Docket number YOR920020332US1) and patent application Ser. No. 10/198,283 filed Jul. 2, 2002 by Hui Lei and Anand 0. Ranganathan for “Method and Apparatus for Providing Extensible Transcoding of Multimedia Content” (IBM Docket number YOR920010625US1), each assigned to a common assignee herewith. The disclosures of these applications are incorporated herein by reference.

### DESCRIPTION

### BACKGROUND OF THE INVENTION

1. Field of the Invention

The present invention generally relates to computer facilitated business processes and, more particularly, to context-aware enablement of human participants in a business process anytime and anywhere. Using the invention, a human user is able to participate and execute tasks in a business process; collaborate with other users, and even allow the system to control the information flow and steps required to accomplish his tasks.

2. Background Description

A business process is “a procedure where documents, information or tasks are passed between participants according to defined sets of rules to achieve or contribute to an overall business goal”. Participants of a business process may be human beings, Web services or other software agents. In particular, human beings form a very important part of many business processes. A great number of large-scale as well as small-scale business processes like product planning, software design, service after sales, travel request approval and candidate evaluation require the engagement of human participants.

Mechanisms concerned with the modeling and execution of business processes are generally referred to as Workflow Management Systems (WFMS) as defined by P. Grefen, K. Aberer, Y. Hoffner, and H. Ludwig. CrossFlow in “Cross-organizational Workflow Management in Dynamic Virtual Enterprises” in International Journal of Computer Systems, Science, and Engineering, 15(5):277-290, 2001. A WFMS provides formalisms through which business processes are defined. It also includes a corresponding workflow engine that carries out automatic scheduling and activation of component tasks according to the defined business process. Most workflow systems are based on the desktop computing paradigm. They employ a workspace metaphor to present tasks that are to be claimed and performed by human participants. Such tasks differ from tasks that are performed by software agents and are referred to as staff activities. Examples of such systems are IBM's Websphere Process Choreographer available at http://www7b.software.ibm.com/wsdd/zones/was/wpc.html and the Dragon Fly Workflow Engine available at http://www.dragonflysoftware.com.au. Apart from these systems, several research efforts engage human participants through workspace-type user interface. Apart from the research efforts already mentioned in this document, another effort following a workspace paradigm is the work of M. Merz, B. Liberman, and W. Lamersdorf in “Using Mobile Agents to Support Interorganizational Workflow-Management”, published in International Journal on Applied Artificial Intelligence, 11(6):551-572, 1997.

A workspace-based user interface has a number of disadvantages: (1) users are constrained to the desktop computing environment, i.e., they do not have access to business processes when they are away from their desktop; (2) a workspace essentially adopts a pull-based approach, where the user is burdened to periodically inspect his workspace to check out pending staff activities; and (3) WFMS allow for indirect and asynchronous people-to-people communication only, but not direct and synchronous exchanges among human participants. The latter form of interaction is in fact very common in business environments.

On the other hand, a large array of collaboration and communication tools exist that support direct people-to-people interaction. Tools range from hardware devices like cell phones, pagers and iPaqs to software systems like Short Messaging Service (SMS), Instant Messaging (IM), email and e-meetings. These heterogeneous modalities offer flexibility and extra opportunities in human collaboration. In particular, they allow for synchronous interaction and proactive engagement of people in collaboration by pushing communication messages to them. However, current collaboration tools have their own limitations: (1) they support ad hoc, unstructured collaboration only, i.e., there is no built-in mechanism for enforcing any policies or structures on the collaboration process; and (2) collaboration tools are not integrated with business processes, i.e., people have to explicitly switch back and forth between business processes and collaboration tools and manually move data between the two.

### SUMMARY OF THE INVENTION

It is therefore an object of the present invention to provide a system and method that addresses the respective limitations in workflow systems and collaboration tools by effectively integrating the two. The invention enables people to engage in business processes anytime and anywhere, using any traditional communication mechanism.

It is a further object of the invention to add orchestration support to collaboration tools by mediating them with a workflow engine.

Various formalisms have been developed for modeling business processes that run on a workflow engine. The invention leverages an extended version of Business Process Execution Language (BPEL) available from http://www 106.ibm.com/developerworks/Webservices/library/ws-bpel/to incorporate human participants in a business process. However, the invention works independent of the type of formalism used to define business processes. The Mercury System described in detail in patent application Ser. No. 10/349,235 (IBM Docket number YOR920020332 μl) also supports integration of heterogeneous communication devices while establishing communication between a caller and a callee. Still, the communication supported is ad hoc and unstructured. The key aspect that sets this invention apart is the additional integrated orchestration support to support structured collaboration as a part of a business process.

According to another aspect of the invention, there is provided a mechanism to integrate WFMS and heterogeneous communication tools, by addressing the challenge of personal mobility. Although a person typically has multiple communication tools, he may have access to only a subset of them at a particular time. Depending on the circumstance, he may also have a preference on which of the available tools to use. So the invented method also dynamically selects an appropriate device (modality) to engage the user for a particular interaction.

The invention embodies five salient features. First, human tasks in business processes are pro-actively pushed to the users. Second, people can participate in business processes from anywhere using a convenient communication device. Third, dynamic user context information is used to guide the selection of a convenient device. Fourth, coordination policies and structure can be imposed to people-to-people collaboration. And finally, collaboration processes can be instantiated programmatically and collaboration results fed back to the calling application.

In a preferred embodiment of the invention, an Interaction Controller (IC) is instituted which acts as a proxy to represent all human participants. The IC receives directives for human participants from the business process running on the Workflow Engine. The Workflow Engine executes the business process and engages human partners and software entities by dispatching various tasks to them. Tasks meant for software partners are communicated to the corresponding software entities by the engine directly. Staff activities are routed to the IC. The IC leverages the use of the Context Service described in detail in patent application Ser. No. 10/198,283 (IBM Docket number YOR920010625US1) that gathers and distributes dynamic context information of the human participants. The Context Service allows the IC to select the access mechanism that is most convenient for a particular human participant. The IC employs an extensible set of Modality Adapters that suffice as access points for specific communication devices and collaboration modalities. The primary job of a Modality Adapter is to interpret tasks being sent by the IC and present it in the modality-specific format. Adapters use device-specific platforms, servers or gateways to communicate with the specified human partner instance.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram showing an embodiment of a system on which the invention is implemented;

FIG. 2 is a block diagram showing the overall flow of a sample travel request approval business process; and

FIG. 3 is a flow diagram illustrating how the Interaction Controller funnels a staff activity to the appropriate device.

### DETAILED DESCRIPTION OF A PREFERRED EMBODIMENT OF THE INVENTION

In a preferred embodiment of the invention, an Interaction Controller (IC) is instituted which acts as a proxy to represent all human participants. The IC receives directives for human participants from the business process running on the Workflow Engine. The Workflow Engine executes the business process and engages human partners and software entities by dispatching various tasks to them. Tasks meant for software partners are communicated to the corresponding software entities by the engine directly. Staff activities are routed to the IC. The IC leverages the use of the Context Service that gathers and distributes dynamic context information of the human participants. The Context Service allows the IC to select the access mechanism that is most convenient for a particular human participant. The IC employs an extensible set of Modality Adapters that suffice as access points for specific communication devices and collaboration modalities. The primary job of a Modality Adapter is to interpret tasks being sent by the IC and present it in the modality-specific format. Adapters use device-specific platforms, servers or gateways to communicate with the specified human partner instance.

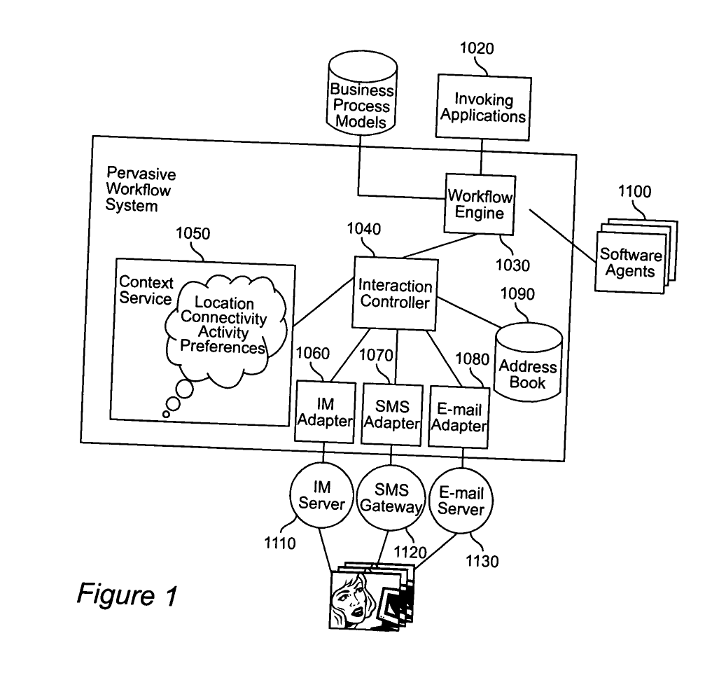

Referring now to the drawings, and more particularly to FIG. 1, there is shown an embodiment of a system on which the invention may be implemented. At the heart of the system is the Interaction Controller (IC) 1040 which interfaces with the Workflow Engine 1030 and the Context Service 1050. The Workflow Engine 1030 executes the business process based on business process models 1010 and engages human partners through software agents 1100 and invoking software applications 1020 by dispatching various tasks to them. The IC 1040 receives specification of individual staff activities from the Workflow Engine 1030 and forwards the engine responses from human partners back to the Workflow Engine 1030. A staff activity specification contains information about the human partner instance intended to carry out the activity and the relevant messages. Upon receiving a staff activity specification, the IC 1040 obtains context information of the partner instance from the Context Service 1050 and determines an appropriate collaboration modality for the partner instance. It uses an Address Book 1090 to look up the modality-specific address (e.g., telephone number, email address, Instant Messaging (IM) identifier) based on the user name. It then establishes communication with the corresponding Modality Adapters (IM adapter 1060 or Short Messaging Service (SMS) adapter 1070 or Email adapter 1080) and supplies it with all the information regarding the staff activity. The modality adapters 1060, 1070 and 1080 are but examples for purposes of illustration only. The invention contemplates the use of a variety of modality adapters, including adapters for instant messaging, Email, e-meeting, discussion threads, phones, pagers and other communication devices commonly used by human beings. Other examples as technologies evolve are also contemplated. Communication is either notification-based (for one-way activities) or request-response based (for two-way activities). For request-response based communication, the IC 1040 also provides the Modality Adapter with the message format representing the reply desired.

There are two possible communication paradigms between the IC 1040 and the Modality Adapters 1060, 1070 and 1080. In a synchronous communication paradigm, the IC 1040 opens a communication session with a Modality Adapter 1060, 1070 or 1080 and blocks until the communication has been completed and the reply received. This paradigm entails a multi-threaded structure of the IC 1040. In an asynchronous communication paradigm, the IC 1040 communicates staff activity information to a Modality Adapter 1060, 1070 or 1080 via events. The Modality Adapter later on establishes a callback to the IC 1040 returning the response from the partner instance.

The Context Service 1050 allows context-aware applications to obtain user context information without having to worry about the details of context derivation and context management. It supports both synchronous query and asynchronous callback context functions, and allows for easy incorporation of new types of context data into the Context Service. The Context Service 1050 provides both dynamic user context information and static user preferences. Dynamic context information currently available from the Context Service includes IM online status, activities and contact means derived from calendar entries, desktop activities, as well as user location reported from a variety of sources such as cellular providers, wireless Local Area Networks (LANs), Global Positioning Satellite (GPS) devices, and handheld Personal Digital Assistants (PDAs) such as Research In Motion Ltd. BlackBerry™ devices. The static user preferences include those used to determine the appropriate collaboration modality for a mobile user. Such preferences are represented as rules. Each rule specifies the modalities that may be used under a particular condition. The rule condition is in terms of the user's dynamic context variables such as location and activity and static attributes such as the identity of the corresponding party. Each rule is optionally associated with a priority value to help resolving conflicts between rules. Modality Adapters 1060, 1070 and 1080 in FIG. 1 allow disparate collaboration mechanisms to be plugged into the system in an extensible manner. They expose a uniform interface to the Interaction Controller 1040 and encapsulate the details of invoking individual collaboration modalities. A Modality Adapter performs three kinds of functions. (I) It interacts with a particular modality server (IM server 1110, SMS gateway 1120 or Email server 1130), initiating and terminating modality-specific connections to human partner instances as necessary. (2) It pushes staff activities to partner instances and funnels communication between the IC and partner instances. It further masks disconnections and retransmissions during the communication. (3) It interprets messages from the IC and presents them to partner instances in a modality-appropriate manner. It also constructs responses to the IC based on modality-specific input from partner instances.

Modality Adapters may be implemented in accordance with the type of the collaboration modality (connection-oriented vs. connectionless). Connection-oriented modalities support two-way, synchronous collaboration. Examples of such modalities are instant messaging (IM) and cell phones. Connectionless modalities support one-way, asynchronous collaboration. Examples include Email and SMS. Adapters for connection-oriented modalities employ a dispatcher and a collection of worker threads. Each worker thread maintains one connection session. A connection is established only if the corresponding partner instance is online or available on the modality server. Adapters for connectionless modalities are based on a state-machine model with state transitions triggered by communication messages from the partner instance. No connection setup and termination are needed in this case as the partner instance does not have to be connected for the communication to take place.

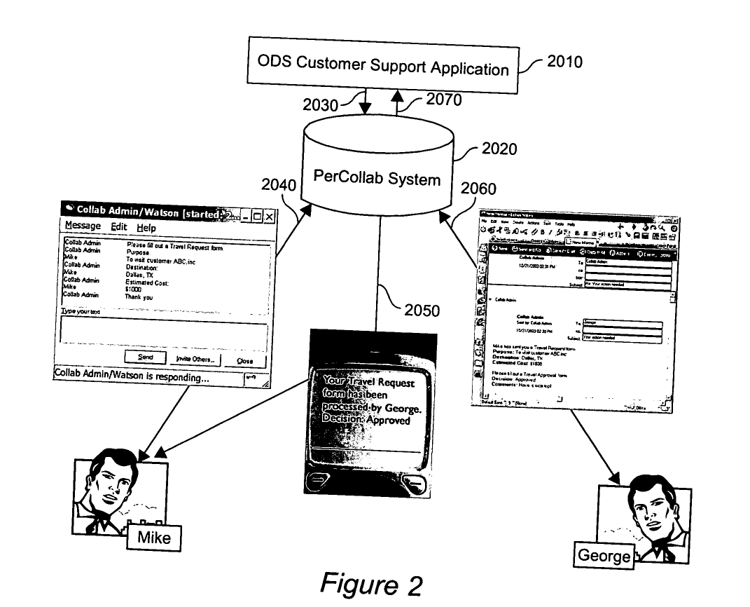

FIG. 2 illustrates the data flow of a business process of Travel Request Approval where staff activities are performed by users using Instant Messaging and Pager service. In Step 2030, the ODS Customer Support Application instantiates the approval process by sending the request to the PerCollab system 2020. In Step 2040, the PerCollab system 2020 uses instant messaging to communicate with Mike prompting him to fill out a Travel Request Form. In Step 2060, the PerCollab system 2020 uses Email to send the filled Travel Request Form to George and instruct him to fill out the attached Approval Form. Once George has replied, PerCollab determines, in Step 2050, that Mike is no longer available through instant messaging and hence sends out the notification of the approval to Mike's SMS device. Finally, the PerCollab system exits the Travel Request Approval process in Step 2070 and returns to the ODS application. In every interaction step, the PerCollab system 2020 selects a communication device based on dynamic user context and prepares the messages in a device-appropriate way.

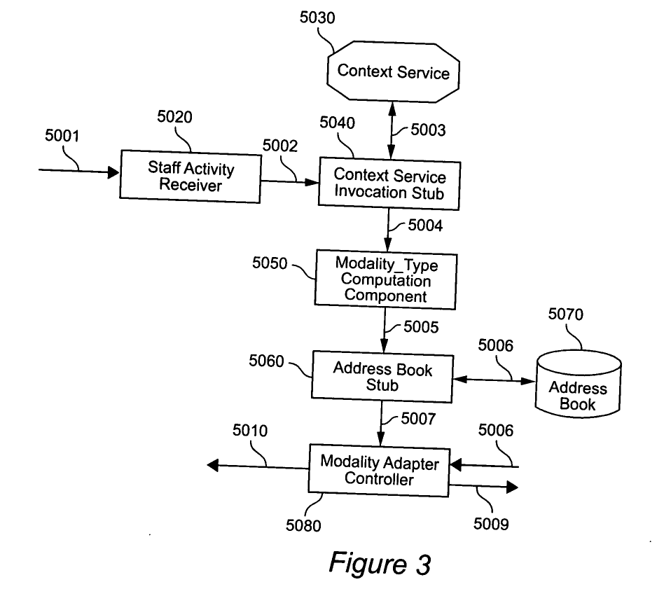

FIG. 3 shows the various steps inside the Interaction Controller 1040 in FIG. 1 taken to funnel a staff activity to an appropriate modality adapter 1060, 1070 or 1080 and send the reply back to the BPEL Engine. The Staff Activity Receiver 5020 receives a task (Step 5001) from the Workflow Engine 1030. The Receiver 5020 passes the request to the Context Service Invocation Stub 5040 (Step 5002). The Context Service Invocation Stub uses the Context Service 5030 (same as the Context Service 1050 in FIG. 1) to derive appropriate context information by passing the USER_ID (a parameter passed to the receiver 5020 in step 5001) to it (Step 5003). It passes the context-specific information gathered (Step 5004) to compute the most appropriate modality to be used for the particular staff activity in Modality_Type Computation Component 5050. The Modality_Type could be either of 1060, 1070 or 1080 or other adapters depending on the implementation of the system. The Modality_Type and the user_id is utilized by the Address Book Stub 5060 to compute the actual Device_Address from the Address Book 5070 (Step 5006). The staff activity is then funneled to the Modality Adapter Controller 5080 (Step 5007) that takes the responsibility of invoking the appropriate adapter (Step 5008), obtain the reply back (Step 5009) and send the reply back to the Workflow Engine (Step 5010).

While the invention has been described in terms of a single preferred embodiment, those skilled in the art will recognize that the invention can be practiced with modification within the spirit and scope of the appended claims.

1. A system for pervasive enablement of business processes, comprising:
a workflow engine that executes a business process model;
a context service that allows context-aware applications to obtain user context information;
an interaction controller that receives specification of individual staff activities from the workflow engine, and upon receiving a staff activity specification, obtains context information of a partner instance from the context service to determine an appropriate collaboration modality for the partner instance, and forwards the engine responses from human partners back to the workflow engine, thereby handling individual interactions with human participants; and
one or more modality adapters that encapsulate details of communicating with a specific collaboration modality.

2. The system in claim 1, wherein the context service provides dynamic context information about human participants.

3. The system in claim 2, wherein said dynamic context information includes a human participants' location, activity, connectivity and preferences.

4. The system of claim 2, wherein the context service supports both synchronous query and asynchronous callback context functions.

5. The system in claim 1, further comprising an address book that maps individual IDs to modality-specific addresses, the interaction controller accessing the address book to look up a modality-specific address.

6. The system in claim 1, wherein the modality adapters include the adapters for instant messaging, email, e-meeting, discussion threads, phones, pagers, and other communication devices.

7. A method for pervasive enablement of business processes, comprising the steps of:
executing a business process model;
storing user context information;
receiving specification of individual staff activities;
obtaining context information of a partner instance from the context information to determine an appropriate collaboration modality for the partner instance;
directing human tasks to one of a plurality of modality adapters, each of which is adapted to exchange data with said human participants in a modality-specific manner; and
gathering responses from human participants via said modality adapter.

8. The method in claim 7, further comprising the step of mapping individual IDs to modality-specific device addresses.

9. The method in claim 7, wherein said directing step is based on an explicit command when instantiating the business process model.

10. The method in claim 7, wherein said directing step is based on dynamic context information on said human participant.

11. The method in claim 10, wherein said dynamic context information includes a human participants' location, activity, connectivity and preferences.

12. The system of claim 10, wherein the directing step supports both synchronous query and asynchronous callback context functions.
